(19) United States
(12) Patent Application Publication
(10) Pub. No.: US 2010/0206119 A1
(43) Pub. Date: Aug. 19, 2010

(54) GRASS SEED BAG END EFFECTOR

(75) Inventors: Dean Ehnes, Vancouver, WA (US); Theodore Vanderheyden, Vancouver, WA (US); Richard Sampson, Vancouver, WA (US); Adrian Berg, Vancouver, WA (US)

Correspondence Address: RYLANDER & ASSOCIATES PC, 406 West 12th Street, Vancouver, WA, 98660, US

(73) Assignee: Columbia/Okura LLC, Vancouver, WA (US)

(21) Appl. No.: 12/699,832

(22) Filed: Feb. 3, 2010

Related U.S. Application Data
(60) Provisional application No. 61/149,962, filed on Feb. 4, 2009.

(51) Int. Cl. B25J 15/00; B25J 18/00

(52) U.S. Cl. 74/490.01; 294/106; 901/31

(57) ABSTRACT

An embodiment is a robotic arm end effector. The end effector generally comprises an actuator assembly, a positioning palm assembly, a claw assembly, a tamp assembly, and an end plate. The end effector of an embodiment may grasp and move bulk items. More specifically, the end effector of an embodiment may grasp bulk items and/or products contained in bags or sacks, move them, and deposit and/or stack the bags or sacks. For example, the end effector of an embodiment may grasp products such as grass or other agricultural seed contained in a synthetic (e.g., poly-weave) or natural fiber bags and stack them on a pallet.

### CROSS-REFERENCE TO RELATED APPLICATION

This application claims priority to co-pending U.S. Provisional Patent Application Ser. No. 61/149,962 filed Feb. 4, 2009, which is incorporated herein by reference.

### FIELD OF THE INVENTION

The present invention relates to a robotic material handling apparatus and method. More particularly, the present invention relates to a palletizing end effector for a robotic arm.

### BACKGROUND

The International Organization for Standardization defines an industrial robot as an automatically controlled, reprogrammable, multipurpose manipulator programmable in three or more axes. Typical applications of industrial robots include welding, painting, ironing, assembly, pick and place, packaging and palletizing, product inspection, and testing. Frequently, industrial robots employ a robotic arm. A robotic arm is a robot manipulator, usually programmable, with similar functions to a human arm. The links of such a manipulator are connected by joints allowing rotational motion (such as in an articulated robot) and/or translational (linear) displacement. The business end of the manipulator is called the end effector. The end effector may be analogous to the human hand and designed to interact with the environment to perform any desired task depending on the application, such as those listed above. Said differently, the end effector is the last link (or end) of the industrial robot representing one or more tools, the location at which one or more tools are attached, and/or one or more manipulators.

One such end effector is a gripper for materials handling (e.g., pick and place and/or packaging and palletizing). Generally speaking, there are four categories of gripping and/or materials handling end effectors for robotic arms. For example, an impactive end effector includes jaws or claws that physically grasp by direct impact upon an object. An ingressive end effector includes pins, needles or hackles that physically penetrate the surface of an object. An astrictive end effector utilizes suction forces applied to an object's surface (e.g., by vacuum, magneto-adhesion, or electro-adhesion). A Kontugutive end effector requires direct contact with an object for adhesion to take place (e.g., utilizing glue, surface tension, or freezing).

A number of devices have provided a materials handling end effector for pick and place and/or packaging and palletizing materials. For example, the following represents a list of known related art:

| | | Date of |
|---|---|---|
| Reference: | Issued to: | Issue/Publication: |
| U.S. Pat. No. 7,234,744 | Osten et al. | Jun. 26, 2007 |
| U.S. Pat. No. 6,579,053 | Grams et al. | Jun. 17, 2003 |
| U.S. Pat. No. 6,305,728 | Holter et al. | Oct. 23, 2001 |
| U.S. Pat. No. 6,234,744 | Cawley | May 22, 2001 |
| U.S. Pat. No. 6,082,080 | Holter et al. | Jul. 4, 2000 |

The teachings of each of the above-listed citations (which does not itself incorporate essential material by reference) are herein incorporated by reference. None of the above inventions and patents, taken either singularly or in combination, is seen to describe the instant invention as claimed.

U.S. Pat. No. 7,234,744 to Osten et al. teaches an end effector for an industrial robot that has the ability to pick up plural objects, selectively rotate the objects, and to adjust the spacing between the plural objects as the products are being carried by the robot to a desired deposit location. This functionality is achieved by locating a rotary actuator at the end of a robot arm and providing a lazy tong linkage assembly to which plural product graspers are affixed where the lazy tong assembly is carried by a rotatable of the rotary actuator. The rotary actuator, the lazy tong assembly and the product graspers are preferably pneumatically actuated.

U.S. Pat. No. 6,579,053 to Grams et al. teaches a robotic containerization and palletizing system having a multiple-fingered end effector. The system includes a frame that defines one or more cells. Each cell has one gantry-type robot, which is mounted in a set of tracks on top of the frame. The robot is movable along two axes and has an arm to which the end effector is mounted. The end effector is designed to grasp trays, tubs, and similar items from a conveyor system running through the cell and load them in a cart or on a pallet. The items are gripped by two sets of fingers. One set of fingers may be mounted to a first plate and another set of fingers may be mounted to a carriage that moves in a horizontal direction, either toward or away from the first set of fingers. Each finger has a main shaft and a bent tip. The shafts are rotatable such that the tips can be moved underneath or out from under a load, depending upon whether a pick-up or drop-off operation is being performed. The end effector is designed to carry out top loading of carts and pallets and includes a measurement and containment plate that is used to detect and measure the height of trays and tubs placed in carts and on pallets. The measurement and containment plate also helps prevent loose mail in unsleeved trays or tubs from falling out of the trays or tubs during robotic transportation. The downward force exerted on the top of the mail tray/tub also helps maintain the grip of the fingers. In order to load carts having shelves, the gripper may also include a shelf-lowering assembly.

U.S. Pat. Nos. 6,305,728 and 6,082,080 to Holter et al. teach a device for mechanically picking and palletizing rectangular objects of various sizes for attachment to a robotic arm. The device includes a pair of rails having a plurality of longitudinally spaced, elongated L-shaped grips extending there through. The distance between the respective rails can be adjusted to accommodate various width containers. The L-shaped grips are capable of pivotal rotation such that their grip ends rotate under the object for picking and palletizing. A pair of pallet hooks having suction cups attached thereto is also provided on the device.

U.S. Pat. No. 6,234,744 to Cawley teaches a method of stacking product directly from a conveyor including conveying a product toward the end of a conveyor, supporting a leading edge of the product as the leading edge exits the conveyor, releasing the leading edge and a following edge of the product with such timing as to cause the product to fall substantially flat onto a platform, and articulating the conveyor, whereby product is stacked in a pattern.

### SUMMARY AND ADVANTAGES

An embodiment of the invention is a robotic arm end effector, comprising a positioning palm assembly including two substantially opposing groups of positioning palm fingers; a claw assembly including two substantially opposing groups of claw fingers, each opposing group of claw fingers at least partially interleaved with the adjacent opposing group of positioning palm fingers; and an end plate disposed substantially at an end of the positioning palm assembly and substantially perpendicularly to each of the two substantially opposing groups of positioning palm fingers. Alternately, an embodiment of the invention is a material handling system comprising a robotic arm and an end effector coupled to the robotic arm, the end effector including a positioning palm assembly including a plurality of positioning palm fingers, a claw assembly including a plurality of claw fingers at least partially interleaved with the plurality of positioning palm fingers, and a tamp assembly disposed at least partially within the positioning palm assembly.

The robotic arm end effector of an embodiment of the present invention presents numerous advantages, including: (1) improved accuracy and precision with which seed-containing or other bulk material-containing bags may be placed and/or stacked on a pallet; (2) improved top surface flatness; (3) improved ability to handle relatively slippery seed-containing or other bulk material-containing bags; (4) improved pallet load stability; (5) improved pallet load density; (6) shortened load height; and (7) improved pallet load aesthetics.

Additional advantages of the invention will be set forth in part in the description that follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows a side view of the end effector of an embodiment.

FIG. 2 shows a front view of the end effector of an embodiment.

FIG. 3 shows a top view of the end effector of an embodiment.

FIG. 4 shows a perspective view of the end effector of an embodiment.

### REFERENCE NUMBERS USED IN DRAWINGS

Turning now descriptively to the drawings, in which similar reference characters denote similar elements throughout the several views, the figures illustrate the robotic arm end effector of the present invention. With regard to the reference numerals used, the following numbering is used throughout the various drawing figures:
10 end effector
20 actuator assembly
22 tamp assembly actuator
24 tamp assembly scissor
26 claw assembly actuator
28 positioning palm assembly actuator
30 positioning palm assembly
32 positioning palm finger
40 claw assembly
42 claw finger
50 tamp assembly
60 end plate

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

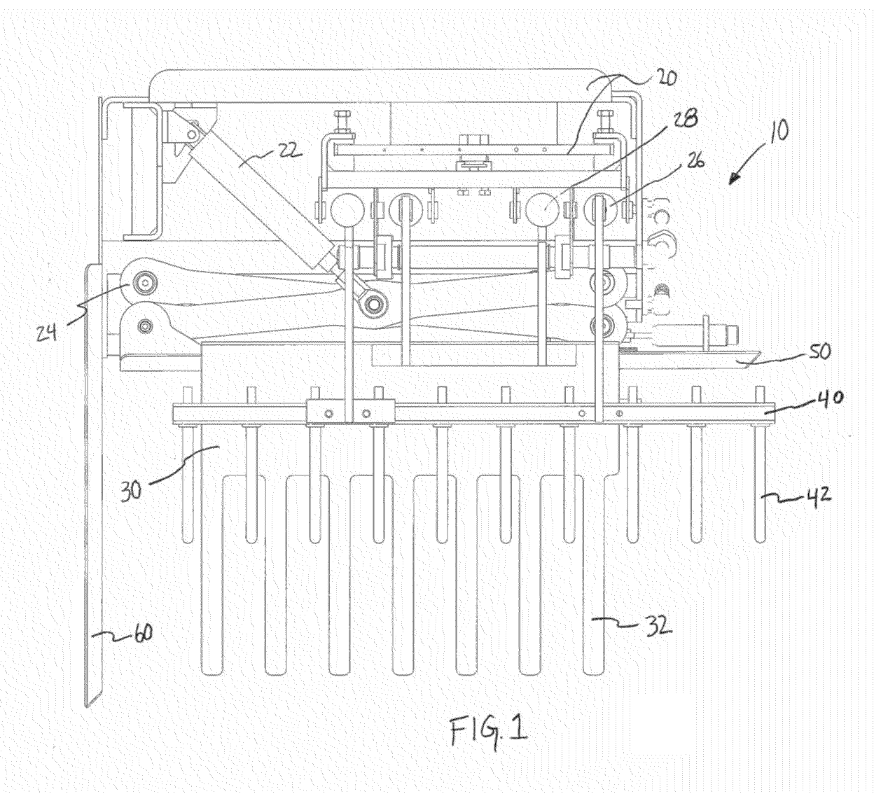

As shown in FIGS. 1-4, an end effector 10 is provided. As shown in FIGS. 1-4, end effector 10 generally comprises an actuator assembly 20, a positioning palm assembly 30, a claw assembly 40, a tamp assembly 50, and an end plate 60. The end effector 10 of an embodiment may grasp and move bulk items. More specifically, the end effector 10 of an embodiment may grasp bulk items and/or products contained in bags or sacks, move them, and deposit and/or stack the bags or sacks. For example, the end effector 10 of an embodiment may grasp products such as grass or other agricultural seed contained in synthetic (e.g., poly-weave) or natural fiber bags and stack them on a pallet (i.e., palletize them) for subsequent shipment. The end effector 10 of an embodiment may provide improved handling of relatively slippery poly-weave bags and may permit functionally and aesthetically improved palletizing of the bags.

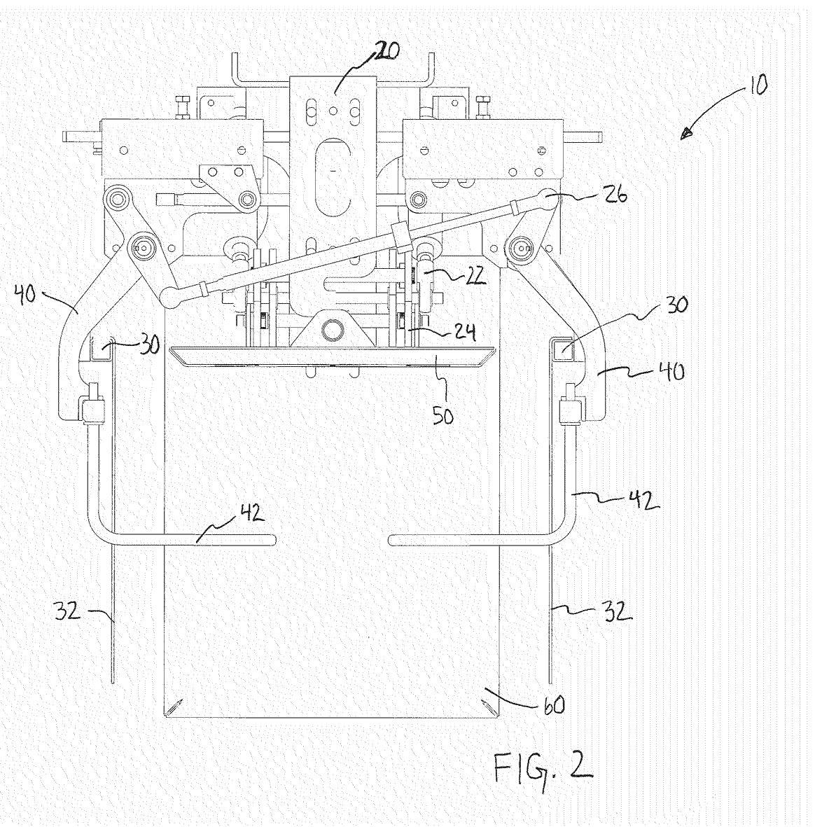

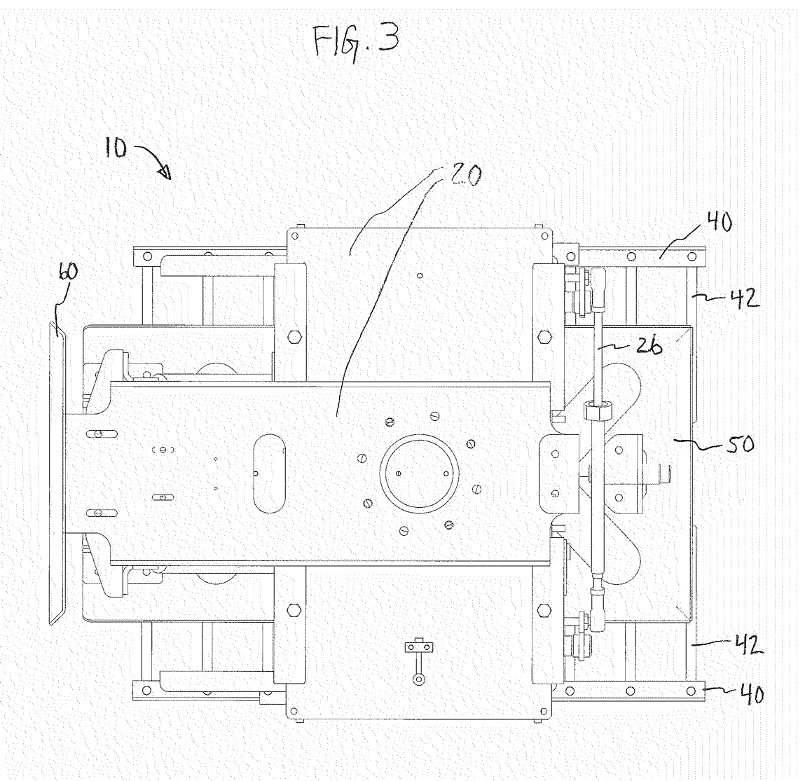

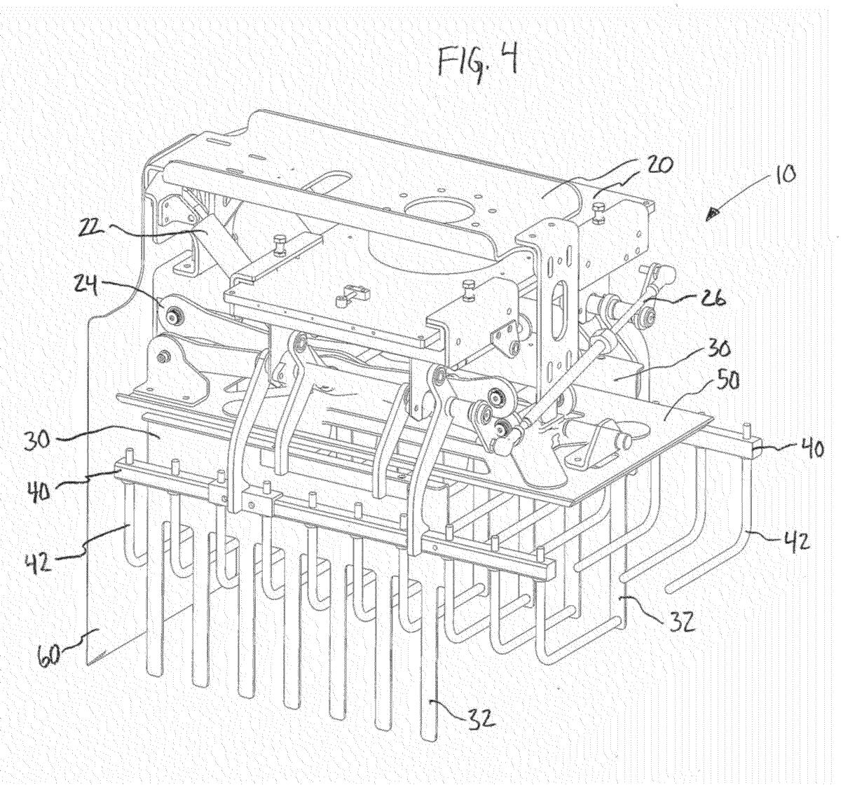

FIG. 1 shows a side view of the end effector 10 of an embodiment, FIG. 2 shows a front view of the end effector 10, FIG. 3 shows a top view of the end effector 10 and FIG. 4 shows a perspective view of the end effector 10. The end effector 10 may couple to and be actuated by a robotic arm (not illustrated). More specifically, the end effector 10 may mechanically, electrically, hydraulically, and/or pneumatically couple to the robotic arm. Further, the actuator assembly 20 of an embodiment of end effector 10 may mechanically, electrically, hydraulically, and/or pneumatically couple to the robotic arm to control at least the claw assembly 40. In an embodiment, the actuator assembly 20 of an embodiment may further mechanically, electrically, hydraulically, and/or pneumatically couple to the robotic arm to control at least the positioning palm assembly 30 and/or the tamp assembly 50.

The robotic arm may provide multiple degrees of freedom for the end effector 10. For example, the robotic arm may provide 3-axis (i.e., X, Y, Z) position, rotation, pitch, and/or yaw. In an embodiment, the actuator assembly 20 may provide additional degrees of freedom, in particular related to handling and/or grasping grass or other agricultural seed contained in synthetic (e.g., poly-weave) or natural fiber bags. For example, while the robotic arm may provide three-axis positioning, rotation, pitch, and/or yaw of the end effector 10, the actuator assembly 20 may provide the static and/or dynamic position and/or operation of the positioning palm assembly 30, the claw assembly 40, and/or the tamp assembly 50.

The end effector 10 of an embodiment may include a positioning palm assembly 30. In an embodiment, the positioning palm assembly 30 may further include a plurality of positioning palm fingers 32 extending vertically therefrom. In an embodiment, the positioning palm assembly 30 may include two groups of positioning palm fingers 32 that may extend vertically from the end effector 10 with a group extending vertically from each lateral side of the end effector 10. Each group of positioning palm fingers 32 in an embodiment includes seven positioning palm fingers 32 that are approximately 9.0 inches long, 1.0 inch wide, and spaced approximately 3.0 inches apart. The positioning palm fingers 32 extending vertically from each lateral side of the end effector 10 may define the lateral sides of a bag cavity into which the end effector 10 may grasp grass or other agricultural seed contained in synthetic (e.g., poly-weave) or natural fiber bags to, for example, palletize them. In an embodiment, the size and/or spacing of the positioning palm fingers 32 may correspond to, for example, the spacing of conveyor rollers of the conveyor that may deliver the bags to the end effector 10. Accordingly, the positioning palm fingers may extend through the spaces between the conveyor rollers to define the bag cavity while the end effector 10 is grasping a bag. Alternately, the bags may be pushed off the conveyor, for example with a pop-up grate or similar actuator, into the bag cavity.

In an embodiment, the positioning palm assembly 30 may be static. In an alternate embodiment, the positioning palm assembly 30 may be dynamic. For example, the positioning palm assembly 30 may couple at least in part to the actuator assembly 20. More specifically, the actuator assembly 20 may include positioning palm assembly actuator 28 to extend, expand, contract, rotate, and/or otherwise actuate each lateral side group of the positioning palm fingers 32. The actuator assembly 20 including positioning palm assembly actuator 28 may extend, expand, contract, rotate, and/or otherwise actuate each lateral side group of positioning palm fingers 32 independently and/or substantially symmetrically. The extension, expansion, contraction, rotation, and/or other actuation of the positioning palm fingers 32, either independently and/or substantially symmetrically, may or may not to alter the size and/or configuration of the bag cavity.

The end effector 10 of an embodiment may further include an end plate 60 extending vertically therefrom, substantially perpendicular to and disposed between the two groups of positioning palm fingers 32. More specifically, the end plate 60 may extend vertically from a back end of the end effector 10 substantially perpendicular to and disposed between the two groups of positioning palm fingers 32. The end plate 60 may accordingly define the back or rear side of the bag cavity into which the end effector 10 may grasp grass or other agricultural seed contained in synthetic (e.g., poly-weave) or natural fiber bags to palletize them. In an embodiment, the end plate 60 may be approximately 15.0 inches wide by approximately 30.0 inches long. Accordingly, in an embodiment, the bag cavity into which the end effector 10 may grasp a bag and/or other article that is defined by the positioning palm fingers 32 and the end plate 60 may be approximately 30.0 inches long by 20.0 inches wide by 8.0 inches tall.

The end effector 10 may further include a claw assembly 40 coupled at least in part to the actuator assembly 20. Like the positioning palm assembly 30, the claw assembly 40 may further include a plurality of claw fingers 42 extending from the end effector 10 in two groups. For example, the claw assembly 40 may include two groups of claw fingers 42 corresponding to the two lateral groups of positioning palm fingers 32. In particular, each group of claw fingers 42 may include ten claw fingers 42 that are at least in part disposed between and/or interleaved with the positioning palm fingers 32. Each claw finger 42 may be substantially “L” shaped, bending substantially at a right angle in toward the bag cavity. In an embodiment, each claw finger 42 may include the substantially right angle bend approximately at its midpoint. Each claw finger 42 is approximately 7.0 inches long, 8.0 inches wide, and spaced approximately 3.0 inches apart.

Like the positioning palm assembly 30, the claw assembly 40 may be dynamic as it may couple at least in part to the actuator assembly 20. More specifically, the actuator assembly 20 may include claw assembly actuator 26 to extend, expand, contract, rotate, and/or otherwise actuate each lateral side group of the claw fingers 42. The actuator assembly 20 including the claw assembly actuator 26 may extend, expand, contract, rotate, and/or otherwise actuate each lateral side group of claw fingers 42 independently and/or substantially symmetrically.

The actuator assembly 20 including the claw assembly actuator 26 may operate at least the claw assembly 40 to grasp grass or other agricultural seed contained in synthetic (e.g., poly-weave) or natural fiber bags to palletize them. To do so, the actuator assembly 20 including the claw assembly actuator 26 may operate the claw assembly 40 between at least two positions. For example, prior to and/or in preparation to grasp a bag, the actuator assembly 20 including the claw assembly actuator 26 may open and/or expand each lateral group of the claw fingers 42 to an open position so that at least a portion of the claw fingers 42 (e.g., the distal portion of the claw finger 42 past the substantially right angle bend) open and/or expand outside the bag cavity defined at least in part by the positioning palm assembly 30 and the end plate 60. As such, at least a portion of the claw fingers 42 may no longer be disposed between or interleaved with the positioning palm fingers 32. The robotic arm may position the end effector 10 such that the grass or other agricultural seed contained in synthetic (e.g., poly-weave) or natural fiber bag is located within the bag cavity. Thereafter, the actuator assembly 20 including the claw assembly actuator 26 may close and/or retract each lateral group of claw fingers 42 to a closed position around the synthetic (e.g., poly-weave) or natural fiber bag.

Once the synthetic (e.g., poly-weave) or natural fiber bag is substantially secured in the bag cavity, the robotic arm may position the end effector 10 adjacent and above, for example, a pallet (or preceding bag or bags already placed and/or stacked on the pallet) after which the actuator assembly 20 may return the claw assembly 40 including claw fingers 42 to the open position to release the bag. Once the bag is released on the pallet and/or preceding bag or bags already palletized, the actuator assembly 20 may actuate the tamp assembly 50, for example with a tamp assembly actuator 22 coupled to a tamp assembly scissor 24, to tamp down (i.e., impress upon) the top of the bag. In an embodiment, the actuator assembly 20 including tamp assembly actuator 22 coupled to a tamp assembly scissor 24 may actuate the tamp assembly 50 multiple strokes or cycles to further tamp down the top of the bag. By doing so, the tamp assembly 50 may substantially form the bag to the topography underlying the bag. Additionally, the actuation of the tamp assembly 50 may substantially flatten the top surface of the bag so that subsequently placed bags may have a more stable surface onto which they may be placed. Accordingly, the final or top layer of bags stacked on the pallet may have a substantially flat top surface.

While the robotic arm including the end effector 10 grasps the bags (e.g., from a conveyer) and releases and tamps the bags (e.g., palletizing the bags) the positioning palm assembly 30 and the end plate 60 may improve the positional accuracy and precision of the bag placement. In particular, the positioning palm assembly 30 and end plate 60 may substantially hold the bags in position on the pallet (or on preceding bags already placed and tamped on the pallet) as they are being released by the actuation of the claw assembly 40 and tamping and/or compression of the bag by tamp assembly 50. The improved positional accuracy and precision of the tamped and/or compressed bags may improve the overall stability of a loaded pallet including a substantially flat load top.

Additionally, in an embodiment, while the claw assembly 40 including claw fingers 42 is in the closed position around a bag, the actuator assembly 20 including tamp assembly actuator 22 coupled to a tamp assembly scissor 24 may further actuate the tamp assembly 50 to more substantially secure the bag (e.g., by pressing against the closed claw fingers 42) while the robotic arm including the end effector 10 is in motion. By doing so, the bag cavity may be substantially defined laterally by the positioning palm assembly 30, the claw assembly 40, and the end plate 60, and substantially defined vertically by the claw assembly 40 (e.g., with the distal ends of the claw fingers 42 past their substantially right able bends) and the tamp assembly 50.

As introduced above regarding the structure of end effector 10, a method of palletizing grass or other agricultural seed contained in synthetic (e.g., poly-weave) or natural fiber bags begins with providing one or more bags, for example with a conveyor system. Once the bag is conveyed to an approximate location, the robotic arm may position the end effector 10 of an embodiment, including the claw assembly 40 in the open position, around the bag substantially without the positioning palm assembly 30, claw assembly 40, and end plate 60 contacting and/or otherwise interfering with the conveyor system. The claw assembly 40 may thereafter close around the bag. In an embodiment, the positioning palm assembly 30 and/or the end plate 60 may improve the accuracy and precision of the bag placement within the claw assembly 40. Thereafter, the tamp assembly 50 may extend to substantially secure the bag against the claw assembly 40 (and in an embodiment against the positioning palm assembly and/or end plate 60).

The robotic arm including the end effector 10 of an embodiment may then position the bag adjacent and above the pallet and/or preceding layer of one or more bags and open the claw assembly 40 to release the bag. The tamp assembly 50 may extend to press the bag against the pallet and/or preceding layer of one or more bags. The tamp assembly 50 may retract and re-extend one or more cycles to further press the bag against the pallet and/or preceding layer of one or more bags. By doing so, the tamp assembly 50 may further substantially flatten the top of each bag. During the placement, release, and one or more tamps, the positioning palm assembly 30 and/or the end plate 60 may substantially maintain the position of the bag. The accurate and precise placement of multiple bags on the pallet may improve the overall load stability of the loaded pallet.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. A robotic arm end effector, comprising:
a positioning palm assembly including two substantially opposing groups of positioning palm fingers;
a claw assembly including two substantially opposing groups of claw fingers, each opposing group of claw fingers at least partially interleaved with the adjacent opposing group of positioning palm fingers; and
an end plate disposed substantially at an end of the positioning palm assembly and substantially perpendicularly to each of the two substantially opposing groups of positioning palm fingers.

2. The robotic arm end effector of claim 1 wherein the two substantially opposing groups of positioning palm fingers are substantially symmetrical, and wherein the two substantially opposing groups of claw fingers are substantially symmetrical.

3. The robotic arm end effector of claim 2 further comprising a tamp assembly disposed substantially between the two substantially opposing groups of positioning palm fingers.

4. The robotic arm end effector of claim 3, the positioning palm assembly, the tamp assembly, and the end plate to define a bag cavity.

5. The robotic arm end effector of claim 4 further comprising an actuator assembly to actuate at least one of the positioning palm assembly, the claw assembly, the tamp assembly, or a combination thereof.

6. The robotic arm end effector of claim 4 further comprising an actuator assembly to actuate the claw assembly between a closed position to grasp and hold a parcel substantially in the bag cavity and an open position to release the parcel from the bag cavity.

7. The robotic arm end effector of claim 4, the two substantially opposing groups of claw fingers further comprising claw fingers that are approximately L-shaped and that bend at a substantially right angle approximately at their midpoints in toward the bag cavity.

8. A material handling system comprising:
a robotic arm; and
an end effector coupled to the robotic arm, the end effector including a positioning palm assembly including a plurality of positioning palm fingers, a claw assembly including a plurality of claw fingers at least partially interleaved with the plurality of positioning palm fingers, and a tamp assembly disposed at least partially within the positioning palm assembly.

9. The material handling system of claim 8, the positioning palm assembly further comprising two substantially opposing groups of positioning palm fingers.

10. The material handling system of claim 9, the claw assembly further comprising two substantially opposing groups of claw fingers, each opposing group of claw fingers at least partially interleaved with the adjacent opposing group of positioning palm fingers.

11. The material handling system of claim 10, the two substantially opposing groups of claw fingers further comprising claw fingers that are approximately L-shaped and that bend at a substantially right angle approximately at their midpoints in toward the tamp assembly.

12. The material handling system of claim 10 further comprising an end plate disposed substantially at an end of the positioning palm assembly and substantially perpendicularly to each of the two substantially opposing groups of positioning palm fingers.

13. The material handling system of claim 12 further comprising an actuator assembly to actuate at least one of the positioning palm assembly, the claw assembly, the tamp assembly, or a combination thereof between a closed configuration to detachably engage a material bag and an open configuration to disengage the material bag.

14. The material handling system of claim 13, the tamp assembly to tamp down the material bag once disengaged.
